(19) United States
(12) Patent Application Publication
(10) Pub. No.: US 2015/0122281 A1
(43) Pub. Date: May 7, 2015

(54) DENTAL FLOSS WITH ENHANCED FUNCTION

(71) Applicant: Knotty Floss, LLC, Newbury Park, CA (US)

(72) Inventor: Elizabeth M. Martens, Newbury Park, CA (US)

(73) Assignee: Knotty Floss, LLC, Newbury Park, CA (US)

(21) Appl. No.: 14/070,938

(22) Filed: Nov. 4, 2013

(51) Int. Cl. A61C 15/04

(52) U.S. Cl. CPC A61C 15/042
USPC 132/200; 132/321; 132/325

(57) ABSTRACT

A dental floss product includes a continuous length of dental floss and a plurality of equally spaced apart knots along the continuous length of dental floss, each of the knots sized for maneuvering through interdental spaces. A method for promoting proper dental care may include placing a first finger or finger nail from a first hand of an individual on a first knot of the dental floss, placing a second finger or finger nail from a second hand of the individual on a second knot of the dental floss, the second knot of the dental floss being a nearest neighbor to the first knot, wrapping the dental floss between the first knot and the second knot around a tooth, and rubbing the side of the tooth with the dental floss between the first knot and the second knot.

### FIELD OF THE INVENTION

The present invention relates to dental hygiene. More particularly, but not exclusively, the present invention relates to a new and improved dental floss.

### BACKGROUND OF THE INVENTION

Dental floss is recognized as an important aspect of proper care and cleansing of the gums and teeth. Yet, conventional dental floss has limitations.

One problem associated with dental floss is mouth access. The difficulty that arises when people attempt to access all areas of their mouth to cleanse their teeth and gums in order to prevent and or treat dental disease is the ability to hold the floss securely. Flossing with traditionally available floss strings requires a fairly high level of neuromuscular coordination and mental maturity due to the many obstacles within the oral cavity and limited space within the mouth. Dental floss is intended to be used in a compact wet environment in which better than fifty percent of the surfaces to be cleaned are not visible. Areas of low visibility are only visible through a mirror image. Some areas of low visibility cannot be seen in a mirror or at all for that matter. For example all areas under the gums (sulcular space) cannot be seen visibly. Mirror images require a high level of depth perception and ability to simply and accurately transpose images as perceived by the eye. Problems may be further compounded when flosses become slick or slippery once introduced into the wet oral cavity.

Floss holders attempt to eliminate the need for holding string dental floss in the hand therefore eliminating the necessity to place one's hands inside their mouth. However, floss holders generally deliver inferior plaque removal when compared with string floss. To achieve maximum access to disease causing biofilm, floss must be able to adhere to the contour of the tooth and reach to the depth of the dental sulcus. All teeth have a rounded contour that continues down the length of the tooth under the gum line to the base of the dental sulcus. Floss held rigidly in a holder is not able to conform to the curvature of the tooth surface and therefore falls short of the desired goal associated with flossing.

Therefore, problems remain. What is needed is a new and improved dental floss.

### SUMMARY OF THE INVENTION

Therefore, it is a primary object, feature, or advantage of the present invention to improve over the state of the art.

It is a further object, feature, or advantage of the present invention to provide a new and improved dental floss.

It is a still further object, feature, or advantage of the present invention to provide a dental floss which is easy to grip without use of a holder.

It is another object, feature or advantage of the present invention to provide a dental floss which is easy to grip even when slick or slippery.

It is a still further object, feature, or advantage of the present invention to provide a dental hygiene product which may assist in improved dental health and increased gum disease prevention and treatment

One or more of these and/or other objects, features, or advantages of the present invention will become apparent from the specification and claims that follow. No single embodiment need provide all objects, features, or advantages as it is contemplated that different embodiments may have different objects, features, or advantages.

According to one aspect, a dental floss product is provided which includes a plurality of dental floss segments and a plurality of knots. The dental floss product includes a first dental floss segment, a second dental floss segment, a first knot between the first dental floss segment and the second dental floss segment, a third dental floss segment, a second knot between the second dental floss segment and the third dental floss segment. The first dental floss segment, the second dental floss segment, third dental floss segment, the first knot, and the second knot are part of a continuous length of dental floss. The first knot and the second knot are sized for maneuvering through interdental spaces. According to another aspect, a dental floss product is provided. The dental floss product includes a continuous length of dental floss and a plurality of equally spaced apart knots along the continuous length of dental floss, each of the knots sized for maneuvering through interdental spaces.

According to yet another aspect, a method for promoting proper dental care is provided. The method includes providing a dental floss product, the dental floss product comprising a continuous length of dental floss and a plurality of equally spaced apart knots along the continuous length of dental floss, each of the knots sized for maneuvering through interdental spaces, placing a first finger or finger nail from a first hand of an individual on a first knot of the dental floss, placing a second finger or finger nail from a second hand of the individual on a second knot of the dental floss, the second knot of the dental floss being a nearest neighbor to the first knot, wrapping the dental floss between the first knot and the second knot around a tooth, and rubbing the side of the tooth in a vertical plane, with the dental floss between the first knot and the second knot.

### BRIEF DESCRIPTION OF THE DRAWINGS

FIG. 1 illustrates dental floss with knots.

FIG. 2 further illustrates the dental floss with knots.

FIG. 3 illustrates an overhand knot within the floss.

FIG. 4 illustrates forming an overhand knot within the floss.

FIG. 5 is a perspective view illustrating an end of one example of floss.

FIG. 6 illustrates use of the floss.

FIG. 7 further illustrates use of the floss.

FIG. 8 illustrates a plurality of individual strands of dental floss which may be packaged together.

FIG. 9 illustrates a floss dispenser container from which floss with knots is dispensed.

### DETAILED DESCRIPTION OF THE PREFERRED EMBODIMENTS

A thin filament (dental floss) in the form of a string or ribbon is provided with knots placed intermittently along the entire length of the filament. The filament used may be formed of synthetic compounds such as Nylon or TEFLON. Nylon is an example of a fiber-forming substance of a long-chain synthetic polyamide. A polyamide is a compound characterized by more than one amide group. TEFLON is the trade name of the polymer polytetrafluoroethylene also known as PTFE.

The floss may be permeated with a variety of distinctive coatings of waxes, vitamins/supplements and flavor additives. The floss may be lightly waxed, waxed or un-waxed. Flavors may be embedded within the floss such as traditional flavors of cinnamon, mint and bubble gum, as well as additional less traditional flavors.

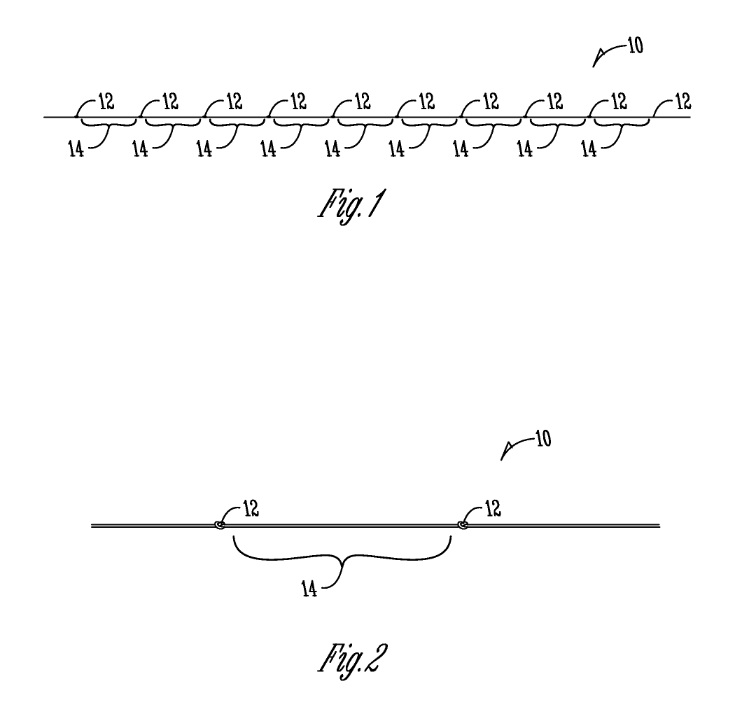

FIG. 1 illustrates a strand or filament of dental floss 10. The dental floss 10 has a plurality of knots 12 which are preferably equally spaced apart by a distance 14. In a preferred embodiment, each knot is spaced apart one inch from its neighboring knots. Of course, it is contemplated that alternative spacing may be used including spacing within the range of 0.75 inches to 1.5 inches or other spacing. However, spacing of about 1.0 inches is advantageous because it encourages proper flossing technique as later described herein.

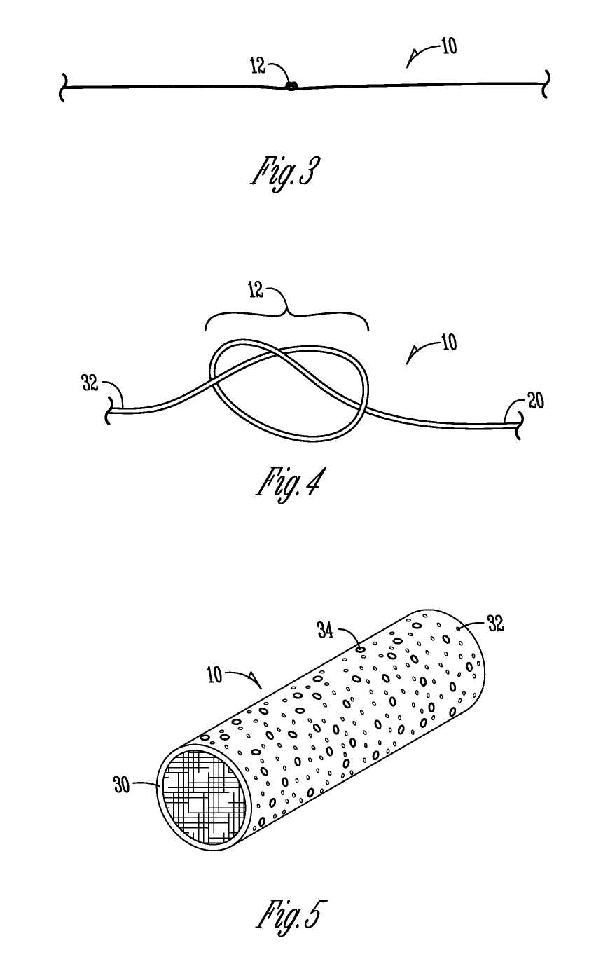

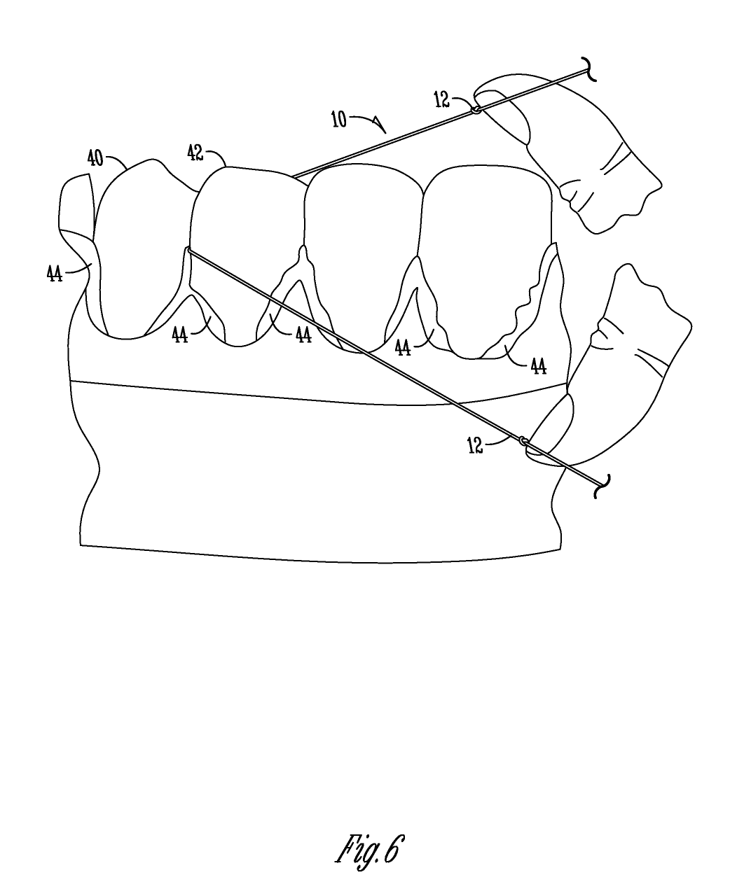

FIG. 2 illustrates in greater detail first and second knots 12 and spacing 14 between the knots. FIG. 3 further illustrates an example of a knot 12 within the dental floss 10 which is not completely tightened. FIG. 4 illustrates the process of forming an overhand knot before the knot is tightened or set. The knot shown is an overhand knot and may be formed by hand or by machine. An overhand knot is an example of a stopper knot. Other examples include a double overhand knot, a figure-8 knot, a Stevedore knot, and an Ashley's stopper knot. Although the overhand knot has been found to be preferable, other types of knots may be used.

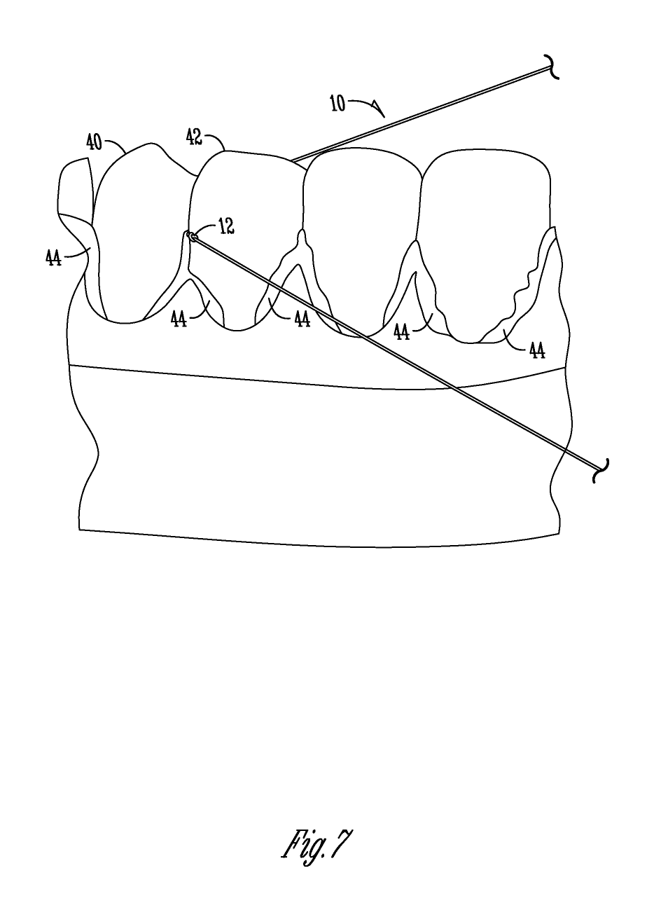

FIG. 5 is a perspective end view of a strand of dental floss. The dental floss 10 may have a coating 30 such as wax and may be embedded with flavoring agents 32 or therapeutic agents 34. The dental floss 10 may be formed of nylon string, teflon string, wax coated nylon string, micro sponge, single weave, double weave, or triple weave. It is contemplated, however that other types of materials may be used. The dental floss 10 may be enhanced by a flavoring agent which may have any one or more of a number of flavors, including, without limitation, cranberry , mint, cinnamon , grape, berry, ginger, tobacco, chili pepper, bubblegum, wasabi , fish oil, tea tree oil, and menthol. The dental floss 10 may be coated with one or more therapeutic agents. Examples of therapeutic agents include, without limitation, vitamins, Chlorhexidine gluconate, fluoride, and calcium phosphate. It is to be further understood that dental floss may have both one or more flavoring agents and/or one or more therapeutic agents.

FIG. 6 illustrates use of the floss. In use, the knot 12 acts as a location to place a finger, or better, a finger nail on the knot 12 and the other finger nail of finger on the opposing hand, on the next closest knot 12. This is intended to train the user to use the floss 10 in the most effective manner. The most effective manner that is achieved is wrapping the one inch length of floss around the rounded side of each tooth 42 as to resemble the letter “C”. Once wrapped properly with the segment of dental floss with the fingers or nails resting on the adjacent knots the cleaning stroke is to rub the side of the tooth in an up and down direction from the highest vertical orientation of the tooth or biting surface of the tooth or “occlusal plane of the tooth to below the gums 44 until the floss 10 can go no further. By staying between the knots 12 the maximum surface of the tooth circumference is making contact with the floss 12. When compared to ordinary floss, most people place a small amount of the floss string in contact with the tooth because the floss is held too far apart between hands. Thus, use of the floss can significantly improve compliance with proper flossing techniques.

In addition, the knot 12 fits around the collar of dental implants to effectively clean this difficult to access ring. Traditional floss does not offer enough body to access the “shelf” of an implant crown or for that matter poorly contoured crowns. Knotted floss offers enough body to clean under these ledges but has traditional thin floss in between the knots so a person can access the space by seating the floss in the traditional way, pushing the floss down in between the teeth. Once the floss is seated, the area can be cleaned by dragging the knot into the shelf space of the crown or implant to pull out debris.

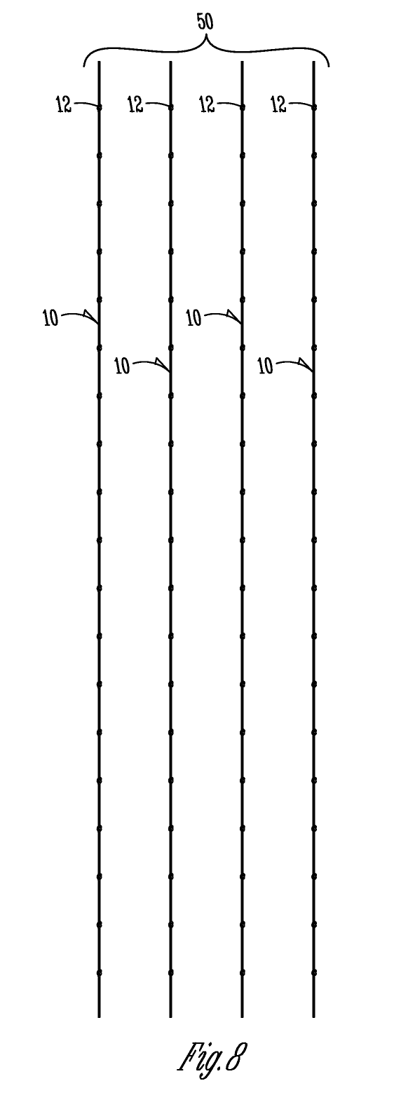

Also, as shown in FIG. 7, the knots 12 may be used to access areas of food impaction in gingival tissue. Once placed under the gums 44, the knots 12 add bulk and body to better remove debris in areas with periodontal disease that have corresponding established depth in the gum space. While removing debris the added bulk of the knots 12 make contact with diseased gum tissue 44. This contact with the knot 12 benefits the gum tissue 44 by improving circulation. Improved circulation helps to re-establish health by improving blood flow to the area of disease.

Thus, it should be understood that as a training device the floss 10 presents the dental professional a product that takes the guess work out of flossing for the patient. The most effective flossing technique is described as an up and down motion with the floss wrapped snuggly against the side of the tooth working down the tooth from point of tooth contact to depth of the gingival sulcus. The overall length of floss should be approximately 18″ with one inch of floss designated as the working piece intended to work the side of the tooth. By instructing the patient to place the working piece of the floss, the section in between two of the intermittent knots, firmly on the side of the tooth the correct and ideal flossing technique is more likely achieved. In order to keep the floss adhered to the side of the tooth and not slide the floss beyond the length of the two opposing knots an up and down or vertical motion must be maintained. A common source of trauma to dental soft tissue during patient flossing is improper technique. Struggling with the grip and the individual's inability to visualize the working length of floss results in a fist gripping, sawing action that cuts and traumatized intra oral soft tissue.

It should also be understood that the dental floss 10 allows for flossing difficult to access areas. Difficult to access areas in the average dental patient's mouth include, but are not limited to; crown margins, over contoured restorations, open embrasures, decay, fractured teeth, gaps in between teeth, dental implant crowns, dental implant posts and orthodontic appliances. Each of these conditions adds an element of difficulty in accessibility that dental home care products currently available are unable to easily and adequately address. The knots act as a built in wedge mechanism to dislodge particles under crown margins and over contoured restorations. The same action of the knots work to dislodge meat, popcorn husks, apple skins, coconut, seeds, grains and other difficult to remove items from areas under the gum line that traditional floss cannot effectively remove. The smoothness and uniformity that traditional flosses offer regardless of material, weave, or coating can glide past the debris and leave the patient vulnerable to a periodontal abscess as the body cannot naturally break down these foods like other food items. Even worse, traditional floss can actually pack the debris further into the dental sulcus causing the patient discomfort and/or expensive and time consuming professional dental procedures to dislodge the irritant. The knots thoroughly reach into cracks, crevasses and gaps while leaving the individual with segments of floss without the knots to be used at their discretion. For the person trying to dislodge debris impacted within orthodontic appliances, the floss 10 simply and effectively pulls food debris and/or biofilm away from the enamel surface without trying to master a new difficult tooth cleansing technique. The usefulness of the knots within the floss 10 is intuitively simple to use and to address all the above common dental problems.

Thus, wrapping the dental floss between the first knot and the second knot around a tooth, and rubbing the side of the tooth in a vertical plane, with the dental floss between the first knot and the second knot may be performed. This is advantageous over horizontal flossing. The spacing of the knots helps patients keep the cleaning stroke in the vertical plane by using the knots as a sort of bumper or reminder to stop the horizontal action.

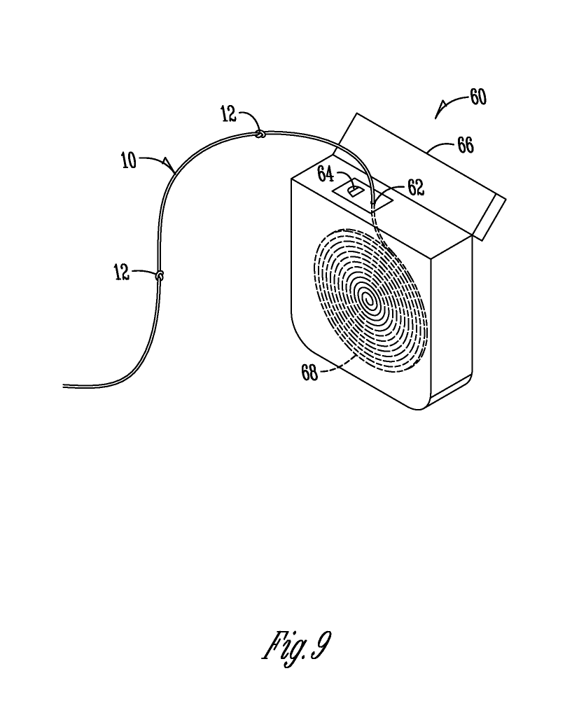

FIG. 8 illustrates a plurality of individual strands of dental floss which may be packaged together. Although it is contemplated that the individual strands may be of different lengths, one length that may be used is 50 cm. Where the knots are spaced apart equidistantly at 1 inch, there are 19 knots per strand.

FIG. 9 illustrates a floss dispenser container from which floss with knots is dispensed. Although a particular container is shown, it is to be understood that any number of types of floss containers may be used. The container 60 includes an opening 62 through which the floss 10 may extend. A metal cutting clip or cutter 64 is provided for cutting a length of the floss 10. A lid or cap 66 is shown which may be used cover the opening 62. Within the container 60, the floss 10 may be wound around a spool 68. Other configurations of spools may be used or the floss 10 may be otherwise placed within the container 60.

The dental floss can provide various advantages. One such advantage relates to mouth access. The difficulty that arises when people attempt to access all areas of their mouth to cleanse their teeth and gums in order to prevent and or treat dental disease is the ability to hold the floss securely. Flossing with traditionally available floss strings requires a fairly high level of neuromuscular coordination and mental maturity due to the many obstacles within the oral cavity and limited space within the mouth. Dental floss is intended to be used in a compact wet environment in which better than fifty percent of the surfaces to be cleaned are not visible. Areas of low visibility are only visible through a mirror image. Mirror images require a high level of depth perception and ability to simply and accurately transpose images as perceived by the eye. The intermittent knots along the length of the floss string act as a grip that can be utilized by placing a finger nail at the base of the knot in order to offer firm, stable pressure along the side of the tooth for thorough and proper cleansing. The knots can also be used without placing a finger nail along the knot but by providing a different texture that can be gripped by the fingers and/or hand. The knots along the length of the floss offer improved overall grip by providing a variation in texture that helps offset the difficulty of working in a moist, compact and blind environment. It further avoids issues associated with flosses which become slick or slippery once introduced into the wet oral cavity.

Samples of Knotty Floss have been made and fifty-two have been field tested thus far. The results of the field testing have shown a preference of Knotty Floss over traditional floss currently available on the market. Test participants were asked to try a length of Knotty Floss on as many or few teeth as they like until they feel like they have a complete idea of the product. These test subjects then answered a few questions about the floss. Participants were then asked to rate the floss based on the following scale of:

1-bad

2-ok

3-good

4-great

Most participants rated the floss a 3 or 4 (good or great) with only two out of fifty-two participants rating the floss a 1 (bad). Participants were then asked which floss they prefer, the floss they currently use or the sample piece of Knotty Floss. The most common preference points sited were grip and better cleaning ability. Participants were then asked for any comments that they wished to make about the product sampled. Common statements made by participants included:

“I like the grip”

“These bumps clean my teeth better”

“I feel like this is doing more that my normal floss”

Therefore, an improved dental floss and related products and methods have been disclosed. It should be understood that the present invention contemplates numerous variations, options, and alternatives. These include variations in the type of knot, variations in the spacing of the knot, variations in the type of material used for the floss, variations in the manner in which the knots are tied (such as by hand or machine), variations in the presence or absence of coatings, flavorings, and therapeutic agents, variations in the type of packaging, and other variations.

1. A dental floss product, comprising:
a first dental floss segment;
a second dental floss segment; and
a first overhand knot between the first dental floss segment and the second dental floss segment;
a third dental floss segment;
a second overhand knot between the second dental floss segment and the third dental floss segment;
wherein the first dental floss segment, the second dental floss segment, third dental floss segment, the first overhand knot, and the second overhand knot are part of and formed from a continuous length of dental floss;
wherein the first overhand knot and the second overhand knot are sized for maneuvering through interdental spaces;
wherein the first knot and the second knots are inline knots in the continuous length of dental floss.

2-3. (canceled)

4. The dental floss product of claim 1 wherein the continuous length of the dental floss is formed from a material selected from the set consisting of nylon string floss, polytetrafluoroethylene string floss, wax coated nylon string floss, micro sponge floss, single weave floss, double weave floss, triple weave floss, braided floss.

5. The dental floss product of claim 1 wherein the continuous length of the dental floss is enhanced with a flavoring agent.

6. The dental floss product of claim 1 wherein the continuous length of the dental floss is enhanced with a therapeutic agent.

7. The dental floss product of claim 1 wherein the first knot and the second knot are spaced apart at a spacing sized to assist in promoting dental floss where a first finger or finger nail is placed at a first knot and a second finger or finger nail is placed at a second knot adjacent the first knot and the dental floss between the first knot and the second knot is pulled back and forth around a circumference of a tooth.

8. A dental floss product comprising:
a continuous length of dental floss;
at least three equally spaced apart overhand knots along the continuous length of dental floss, each of the knots sized for maneuvering through interdental spaces, each of the knots positioned inline being formed from the continuous length of dental floss.

9. The dental floss product of claim 8 wherein spacing between the knots is sized to assist in promoting dental floss use where a first finger or finger nail is placed at a first knot and a second finger or finger nail is placed at a second knot adjacent the first knot and the dental floss between the first knot and the second knot is pulled up and down along a tooth.

10. The dental floss product of claim 8 wherein each of the knots is a stopper knot.

11. (canceled)

12. The dental floss product of claim 10 wherein the continuous length of the dental floss is enhanced with a flavoring agent.

13. The dental floss product of claim 11 wherein the continuous length of the dental floss is enhanced with a therapeutic agent.

14. The dental floss product of claim 8 further comprising at least one additional continuous lengths of dental floss.

15. The dental floss product of claim 8 further comprising:
a spool wherein the continuous length of dental floss is wound on the spool;
a container, the continuous length of the dental floss disposed within the container; and
a cutter mounted on the container for cutting the floss.

16. A method for promoting proper dental care, comprising:
providing a dental floss product, the dental floss product comprising a continuous length of dental floss and a plurality of equally spaced apart overhand knots along the continuous length of dental floss, each of the overhand knots sized for maneuvering through interdental spaces and each of the overhand knots formed inline along the continuous length of dental floss;
placing a first finger or finger nail from a first hand of an individual on a first overhand knot of the dental floss;
placing a second finger or finger nail from a second hand of the individual on a second overhand knot of the dental floss, the second knot of the dental floss being a nearest neighbor to the first overhand knot;
wrapping the dental floss between the first overhand knot and the second overhand knot around a tooth; and
rubbing the side of the tooth with the dental floss between the first overhand knot and the second overhand knot.
